(19) United States
(12) Patent Application Publication
(10) Pub. No.: US 2026/0317659 A1
(43) Pub. Date: Oct. 15, 2026

(54) DETERGENT GRANULES CONTAINING PRECIPITATED CALCIUM CARBONATE HAVING MORPHOLOGY OF PRISMATIC

(71) Applicant: The Procter & Gamble Company, Cincinnati, OH (US)

(72) Inventors: Dan XU, Beijing (CN); Ying HE, Beijing (CN); Wenhui FENG, Beijing (CN); Yiqun ZHANG, Beijing (CN)

(21) Appl. No.: 19/681,584

(22) Filed: May 19, 2026

Related U.S. Application Data
(63) Continuation of application No. PCT/CN2024/070574, filed on Jan. 4, 2024.

(51) Int. Cl. C11D 7/12; C11D 3/386; C11D 17/00; C11D 17/06

(52) U.S. Cl. CPC C11D 7/12; C11D 3/38609; C11D 3/38636; C11D 3/38645; C11D 17/0039; C11D 17/06

(57) ABSTRACT

This disclosure is related to detergent granules containing precipitated calcium carbonate having a morphology of prismatic, as well as a solid detergent composition containing such detergent granules, and methods of laundering fabric by using the same.

### FIELD OF THE INVENTION

This invention relates to detergent granules containing precipitated calcium carbonate having a morphology of prismatic, as well as a solid detergent composition comprising such detergent granules, and methods of laundering fabric by using the same.

### BACKGROUND OF THE INVENTION

Granular detergent compositions of today are incorporating larger amounts and greater varieties of cleaning actives, which enable a myriad of benefits including superior cleaning, sensorial, environmental sustainability, convenience, and efficiency. However, there are still some other unmet consumer needs in the field of laundry. Particularly, one of the unmet needs is color protection, e.g. to prevent color fading or color bleeding of colored textiles during the wash cycles.

Precipitated calcium carbonates have been used as a builder and/or a flow aid in dry laundry products. Particularly, some research indicated that finely divided precipitated calcium carbonates would significantly improve the detergency, probably by preventing the formation of inorganic deposits on washed fabrics. However, it is unknown if precipitated calcium carbonates can have any effect on color protection. Further, it is also unknown if precipitated calcium carbonates can provide any benefit for softening performance.

Surprisingly, the inventors of the present invention unexpectedly discovered that precipitated calcium carbonates having a morphology of prismatic in dry laundry products can provide a significantly improved color protection compared to precipitated calcium carbonates having other morphologies. Further, the inventors of the present invention unexpectedly discovered that precipitated calcium carbonates having a morphology of prismatic in dry laundry products can provide a softening performance.

### SUMMARY OF THE INVENTION

The present invention relates to a solid detergent composition comprising a plurality of detergent granules, wherein said each of said detergent granule comprises precipitated calcium carbonate in which the precipitated calcium carbonate comprises calcium carbonate particles having a morphology of prismatic.

In some embodiments, the precipitated calcium carbonate is characterized by:
a bulk density ranging from 100 g/L to 1000 g/L, preferably from 150 g/L to 800 g/L, more preferably from 200 g/L to 600 g/L, most preferably from 250 g/L to 400 g/L; and/or
a particle size distribution characterized by: (1) a D50 ranging from 0.1 micron to 50 microns, preferably from 0.5 microns to 20 microns, more preferably from 1 micron to 10 microns, most preferably from 2 microns to 5 microns; and/or (2) a D90 of less than 50 microns, preferably less than 20 microns, more preferably less than 15 microns, most preferably less than 10 microns; and/or
a moisture content of less than 3%, preferably less than 2%, more preferably less than 1%, most preferably less than 0.5%; and/or
a surface area of from 1 m²/g to 20 m²/g, preferably from 2 m²/g to 15 m²/g, preferably from 3 m²/g to 10 m²/g, more preferably from 3.5 m²/g to 9 m²/g.

In some embodiments, the precipitated calcium carbonate may further comprise calcium carbonate particles having a morphology of cubic. Preferably, the precipitated calcium carbonate comprises calcium carbonate particles having a morphology of prismatic as a major part and calcium carbonate particles having a morphology of cubic as a minor part.

In some embodiments, the precipitated calcium carbonate content ranges from 0.1% to 9%, preferably from 0.5% to 8%, more preferably from 1% to 7%, most preferably from 1.2% to 6%, for example 1%, 2%, 3%, 4%, 5%, 6% or any ranges therebetween, by total weight of said solid detergent composition.

In some embodiments, said each of said detergent granule comprises a base particle comprising one or more surfactants; and a coating layer over said base particle, said coating layer comprising precipitated calcium carbonate. Preferably, the base particle is substantially free of, preferably essentially free of, precipitated calcium carbonate.

In some embodiments, the surfactant content ranges from 6% to 70%, preferably from 8% to 60%, more preferably from 10% to 50%, most preferably from 15% to 40%, for example 15%, 20%, 25%, 30%, 35% or any ranges therebetween, by total weight of said solid detergent composition.

In some embodiments, said base particle comprises one or more anionic surfactants selected from the group consisting of: (1) a C₁₀-C₂₀ linear or branched alkylalkoxylated sulfate (AAS) surfactant; (2) a C₆-C₂₀ linear or branched unalkoxylated alkyl sulfate (AS) surfactant; (3) a C₁₀-C₂₀ linear alkyl benzene sulphonate (LAS) surfactant; and (4) combinations thereof.

In some embodiments, each of said detergent granules further comprises alkali metal carbonate. Preferably, the content of alkali metal carbonate ranges from 6% to 70%, preferably from 8% to 60%, more preferably from 10% to 50%, most preferably from 15% to 40%, by total weight of said solid detergent composition.

In some embodiments, each of said detergent granules further comprises one or more ingredients selected from the group consisting of polymers, silicones, perfumes, nonionic surfactants, and combinations thereof. Preferably each of said detergent granules further comprises a mixture of perfume(s) and nonionic surfactant(s).

In some embodiments, each of said detergent granules further comprises one or more enzymes. Preferably each of said detergent granules further comprises a lipase.

In some embodiments, the base particles of said detergent granules are selected from the group consisting of spray-dried particles, agglomerates, and mixtures thereof.

In another aspect, the present invention relates to a method of laundering fabric, comprising the steps of:
a) providing a solid detergent composition comprising a plurality of detergent granules;
b) adding said solid detergent composition into water or an aqueous solution having a hardness of at least 1.2 mmol/L to form a laundry washing liquor; and
c) contacting fabrics in need of laundering with said laundry washing liquor,
wherein said each of said detergent granule comprises precipitated calcium carbonate having a morphology of prismatic.

In some embodiments, the water or the aqueous solution has a hardness of from 1.2 mmol/L to 50 mmol/L, preferably from 1.2 mmol/L to 40 mmol/L, more preferably from 1.5 mmol/L to 30 mmol/L, for example 1.5 mmol/L, 1.7 mmol/L, 2.0 mmol/L, 2.1 mmol/L or any ranges therebetween, for calcium.

In some embodiments, precipitated calcium carbonate having a surface area of from 1 m²/g to 20 m²/g, from 2 m²/g to 9 m²/g, preferably from 3 m²/g to 8 m²/g, more preferably from 3.5 m²/g to 7 m²/g, for example 3 m²/g, 3.5 m²/g, 4 m²/g, 4.5 m²/g, 5 m²/g, 5.5 m²/g, 6 m²/g, 6.5 m²/g or any ranges therebetween.

In another aspect, the present invention relates to use of a plurality of detergent granules in preventing color fading or color bleeding of a colored fabric, wherein said each of said detergent granule comprises precipitated calcium carbonate in which the precipitated calcium carbonate has a morphology of prismatic.

### BRIEF DESCRIPTION OF THE DRAWINGS

FIG. 1 shows SEM photos of precipitated calcium carbonate particles having different morphologies. Particularly, PCC-A has a morphology of prismatic (major) and cubic (minor), PCC-B has a morphology of scalenohedral, PCC-C has a morphology of scalenohedral, and PCC-D has a morphology of cubic.

FIG. 2 shows results of colour protection test for solid detergent compositions containing PCC in which PCC having a morphology of prismatic can provide a better color protection compared to PCC having other morphologies.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described. The terms “include”, “includes” and “including” are meant to be non-limiting.

As used herein, the term “granule” or “particle” refers to a solid matter of minute quantity, such as a powder, granule, encapsulate, microcapsule, and/or prill. The detergent granules or base particles of the present invention can be spheres, rods, plates, tubes, squares, rectangles, discs, stars or flakes of regular or irregular shapes, but they are non-fibrous. The detergent granules or base particles of the present invention may have a median particle size (D50) of about 2000 μm or less, as measured according to the Particle Size Distribution Test described herein in Test 3. Preferably, the detergent granules or base particles of the present invention have a median particle size (D50) ranging from about 1 μm to about 2000 μm, more preferably from about 10 μm to about 1800 μm, still more preferably from about 50 μm to about 1700 μm, still more preferably from about 100 μm to about 1500 μm, still more preferably from about 250 μm to about 1000 μm, most preferably from about 300 μm to about 800 μm, as measured according to the Particle Size Distribution Test described herein in Test 3.

As used herein, the term “detergent granule” or “base particle” refers to granules or particles containing at least one surfactant, preferably at least one anionic surfactant.

As used herein, the term “coating layer” means a partial or complete coating of a layering material over the outer surfaces of a particulate or granular material, or at least a portion of such outer surfaces. Such coating layer can be either continuous or discontinuous.

As used herein, the term “a solid detergent composition” refers to a solid composition, such as granular or powder-form all-purpose or heavy-duty washing agents, e.g., for cleaning: (1) fabrics, dishes, and/or hard surface, which in such context include laundry detergents, dish detergents, hard surface cleansers as well as cleaning auxiliaries such as bleach, rinse aids, additives, or pre-treat types; (2) hair, hair follicles, skin, teeth, and the oral cavity, which in such context include hand cleansing products, teeth cleaning or treating products, oral cavity cleaning or treating products, hair shampoos or conditioners or other hair treatment products, body wash or other body cleansing products, shaving preparation products, personal care products, deodorizing products, and the like.

As used herein, the term “water-soluble” refers to the ability of a sample material to completely dissolve in or disperse into water leaving no visible solids or forming no visibly separate phase, when at least about 25 grams, preferably at least about 50 grams, more preferably at least about 100 grams, most preferably at least about 150 grams, of such material is placed in one liter (1 L) of deionized water at 20° C. and under the atmospheric pressure with sufficient stirring.

As used herein, the terms “consisting essentially of” means that the composition contains no ingredient that will interfere with benefits or functions of those ingredients that are explicitly disclosed. Further, the term “substantially free of” or “substantially free from” means that the indicated material is present in the amount of from 0 wt % to about 5 wt %, preferably from 0 wt % to 3 wt %. The term “essentially free of” means that the indicated material is present in the amount of from 0 wt % to about 1 wt %, preferably from 0 wt % to about 0.5 wt %, more preferably from 0 wt % to about 0.1 wt %, most preferably it is not present at analytically detectable levels.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

### Precipitated Calcium Carbonate (PCC)

The precipitated calcium carbonate (PCC) contained in the detergent granule comprises calcium carbonate particles having a morphology of prismatic.

In some embodiments, the PCC contained in the detergent granule has a relatively low surface area, for example from 1 m²/g to 20 m²/g. Preferably, the PCC has a surface area of from 1 m²/g to 9 m²/g, preferably from 2 m²/g to 8 m²/g, more preferably from 3 m²/g to 7 m²/g, most preferably from 3.5 m²/g to 6 m²/g.

In some embodiments, each of said detergent granule comprises a base particle comprising one or more surfactants; and a coating layer over said base particle, said coating layer comprising precipitated calcium carbonate. In some preferred embodiments, PCC in the detergent composition according to the present invention is mainly present in a coating layer outside of the base particles with little or no PCC inside the base particles. Preferably, the PCC content in the finished product, i.e., the solid detergent composition, is no more than 10%, preferably from 0.1% to 10%, more preferably from 0.2% to 9%, still more preferably from 0.5% to 8%, still more preferably from 1% to 7%, for example, 1%, 2%, 3%, 4%, 5%, 6%, 7% or any ranges therebetween, by total weight of said solid detergent composition.

The PCC suitable for use in the present invention can be prepared by any suitable precipitation process. For example, it can be prepared by a so-called carbonation process, in which gaseous carbon dioxide is passed into a suspension of calcium hydroxide that is derived from limestone. For another example, it can be formed by in-solution reaction between any soluble calcium salt (e.g., CaCl₂), CaSO₄ or CaOH₂) and any soluble carbonate salt (e.g., Na₂CO₃ or K₂CO₃), followed by a drying step. Furthermore, PCC can be formed by a so-called Slag2PCC process, in which steel converter slag, a waste material from the steelmaking industry, is used as a calcium source (rather than limestone).

In a preferred embodiment, the PCC used by the present invention is characterized by a bulk density ranging from 100 g/L to 1000 g/L, preferably from 150 g/L to 800 g/L, more preferably from 200 g/L to 600 g/L, most preferably from 250 g/L to 400 g/L, as measured by Test 1 hereinafter.

The PCC may be characterized, either in addition to or separately from the above-mentioned bulk density, by a surface area of from 2 m²/g to 8 m²/g, preferably from 3 m²/g to 7 m²/g, more preferably from 3.5 m²/g to 6 m²/g, for example, 3 m²/g, 3.5 m²/g, 4 m²/g, 4.5 m²/g, 5 m²/g, 5.5 m²/g, 6 m²/g or any ranges therebetween, as measured by Test 2 hereinafter.

The PCC may be characterized, either in addition to or separately from the above-mentioned bulk density and/or surface area, a particle size distribution characterized by: (1) a D50 ranging from 0.1 micron to 50 microns, preferably from 0.5 microns to 20 microns, more preferably from 1 micron to 10 microns, most preferably from 2 microns to 5 microns; and/or (2) a D90 of less than 50 microns, preferably less than 20 microns, more preferably less than 15 microns, most preferably less than 10 microns, as measured by Test 3 hereinafter.

The PCC as used in the present invention may have a moisture content of less than 3%, preferably less than 2%, more preferably less than 1%, most preferably less than 0.5%, as measure by Test 4 hereinafter.

The PCC as used in the present invention may be characterized by a Dynamic Vapor Sorption of less than 0.5%, preferably less than 0.4%, more preferably less than 0.3%, most preferably less than 0.2%, when measured at 50% Equilibrium Relative. Dynamic Vapor Sorption (DVS) value is indicative of the ability of a material to absorb moisture. As shown by measurements provided hereinafter, PCC has a DVS that is similar to ground calcium carbonate (GCC) but significantly smaller than zeolite. Therefore, the performance of PCC as a flow aid, which is comparable to (or even slightly better than) zeolite and significantly better than GCC, is surprising and unexpected considering their respective Dynamic Vapor Sorption values.

The PCC as used in the present invention may be characterized by a Ring Shear Flowability of less than 3.5, preferably less than 3, more preferably less than 2.5, most preferably less than 2, when measured at 20° C. Ring Shear Flowability is an indication of the flowability of a material itself. The higher the Ring Share Flowability of a material, the better the flowability. By itself, PCC is characterized by a Ring Shear Flowability that is comparable with GCC but significantly poorer than zeolite and. Therefore, the observed performance of PCC as a flow aid, which is comparable with (or even slightly better than) zeolite and significantly better than GCC, is surprising and unexpected considering their respective Ring Shear Flowability values.

### Base Particles

The base particles of the present disclosure loosely refer to any detersive granules or particles containing at least one surfactant, over which the PCC is coated to form a coating layer. The surfactant content in the finished product, i.e., the solid detergent composition, may range from 5% to 80%, preferably from 6% to 70%, more preferably from 8% to 60%, still more preferably from 10% to 50%, most preferably from 15% to 40%, for example 10%, 15%, 20%, 25%, 30%, 35%, 40%, 45%, 50% or any ranges therebetween, by total weight of said solid detergent composition.

Preferably, the base particles as used in the present invention are spray-dried particles. Alternatively, the base particles can be agglomerates or a mixture of spray-dried particles and agglomerates.

The base particles may comprise one or more surfactants selected from the group consisting of anionic surfactants, nonionic surfactants, zwitterionic surfactants, amphoteric surfactants, cationic surfactants, and combinations thereof.

Suitable anionic detersive surfactants include sulphonate and sulphate detersive surfactants. Suitable sulphonate detersive surfactants include methyl ester sulphonates, alpha olefin sulphonates, alkyl benzene sulphonates (especially alkyl benzene sulphonates, preferably C10-13 alkyl benzene sulphonate), alkyl sulphates, alkyl alkoxylated sulphates (preferably alkyl ethoxylated sulphates, preferably a C8-C18 alkyl alkoxylated sulphate, preferably a C8-C18 alkyl ethoxylated sulphate), and alkyl ether carboxylates. The alkyl sulphate, alkyl alkoxylated sulphate and alkyl benzene sulphonates may be linear or branched, substituted or un-substituted, and may be derived from petrochemical material or biomaterial. Suitable alkyl benzene sulphonate (LAS) is obtainable, preferably obtained, by sulphonating commercially available linear alkyl benzene (LAB). Suitable LAB includes low 2-phenyl LAB and high 2-phenyl LAB, such as those supplied by Sasol under the tradename Hyblene®. Suitable sulphate detersive surfactants include alkyl sulphate, preferably C8-C18 alkyl sulphate, or predominantly C-12 alkyl sulphate.

Preferably, the base particles comprise one or more anionic surfactants selected from the group consisting of: (1) a C₁₀-C₂₀ linear or branched alkylalkoxylated sulfate (AAS) surfactant; (2) a C₆-C₂₀ linear or branched unalkoxylated alkyl sulfate (AS) surfactant; (3) a C₁₀-C20 linear alkyl benzene sulphonate (LAS) surfactant; and (4) combinations thereof. More preferably, the base particles comprise an AS surfactant that contains from 80% to 100%, preferably from 85% to 100%, of C₆-C₁₄ AS by total weight of said AS surfactant (“Mid-Cut AS”).

Other anionic surfactants suitable for inclusion into the base particles of the present invention include C₆-C₂₀ linear or branched alkyl sulfonates, C₆-C₂₀ linear or branched alkyl carboxylates, C₆-C₂₀ linear or branched alkyl phosphates, C₆-C₂₀ linear or branched alkyl phosphonates, C₆-C₂₀ alkyl N-methyl glucose amides, C₆-C₂₀ methyl ester sulfonates (MES), and combinations thereof.

Suitable non-ionic surfactants are selected from the group consisting of: C8-C18 alkyl ethoxylates (such as NEODOL® non-ionic surfactants from Shell); C6-C12 alkyl phenol alkoxylates wherein preferably the alkoxylate units are ethyleneoxy units, propyleneoxy units or a mixture thereof; C12-C18 alcohol and C6-C12 alkyl phenol condensates with ethylene oxide/propylene oxide block polymers (such as Pluronic® from BASF); alkylpolysaccharides, preferably alkylpolyglycosides; methyl ester ethoxylates; polyhydroxy fatty acid amides; ether capped poly(oxyalkylated) alcohol surfactants; and mixtures thereof.

Preferred non-ionic detersive surfactants are alkyl polyglucosides and/or alkyl alkoxylated alcohols. The alkyl alkoxylated alcohols are preferably C8-C18 alkyl alkoxylated alcohols with an average degree of alkoxylation of from 1 to 50, preferably from 1 to 30, or from 1 to 20, or from 1 to 10. More preferably, the alkyl alkoxylated alcohols are C8-C18 alkyl ethoxylated alcohols having an average degree of ethoxylation of from 1 to 10, preferably from 1 to 7, more preferably from 1 to 5, and most preferably from 3 to 7. The alkyl alkoxylated alcohol can be linear, branched, and substituted or un-substituted. Suitable nonionic surfactants also include those sold under the tradename Lutensol® from BASF.

Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, e.g., amido propyldimethyl amine (APA). Suitable cationic detersive surfactants also include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

(R)(R₁)(R₂)(R₃)N⁺X⁻
wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, for example chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Suitable examples of zwitterionic surfactants include: derivatives of secondary and tertiary amines, including derivatives of heterocyclic secondary and tertiary amines; derivatives of quaternary ammonium, quaternary phosphonium or tertiary sulfonium compounds; betaines, including alkyl dimethyl betaine, cocodimethyl amidopropyl betaine, and sulfo and hydroxy betaines; amine oxides, including C8-C18 (preferably C12-C18) amine oxides; N-alkyl-N,N-dimethylammino-1-propane sulfonate, where the alkyl group can be C₈ to C₁₈. Preferred zwitterionic detersive surfactants are amine oxides and/or betaines.

Suitable amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof.

In a particularly preferred embodiment of the present invention, the base particles comprise, by total weight of said base particles:
(a) from 4% to 35% of anionic surfactant, preferably LAS;
(b) from 0% to 8%, preferably from 0% to 4%, of zeolite builder;
(c) from 0% to 4%, preferably substantially free, of phosphate builder;
(d) from 0% to 8%, preferably from 0% to 4%, more preferably substantially free, of sodium carbonate;
(e) from 0% to 8% of sodium silicate;
(f) from 1% to 10%, preferably from 1% to 8%, more preferably from 1% to 6%, of an organic acid; and
(g) from 1% to 10%, preferably from 1% to 8%, more preferably from 1% to 6%, of magnesium sulphate,
   wherein said base particles has an equilibrium pH of 8.5 or less, preferably 7.5 or less, more preferably 7.0 or less, at 1 wt % dilution in deionized water at 20° C.

The base particles may comprise alkalinity agents such as NaOH. This allows the detergent formulator to formulate the base detergent particle pH according to needs, for example to be compatible with the pH profile of the solid detergent product.

A preferred organic acid in such bas particles is a carboxylic acid, preferably citric acid. Other suitable acids include formic acid, acetic acid, propionic acid, butyric acid, caprylic acid and lauric acid, stearic acid, linoleic acid and acrylic acid, methacrylic acid, chloroacetic acid and citric acid, lactic acid, glyoxylic acid, acetoacetic acid, oxalic acid, malonic acid, adipic acid and phenylacetic acid, benzoic acid, salicylic acid, glycine and alanine, valine, aspartic acid, glutamic acid, lysine and phenylalanine, nicotinic acid, picolinic acid, fumaric acid, lactic acid, benzoic acid, glutamic acid; succinic acid, glycolic acid. Preferably, the organic acid is selected from the group citric acid, malic acid, succinic acid, lactic acid, glycolic acid, fumaric acid, tartaric acid, and formic acids and mixtures thereof. More preferably, the acid is citric acid, lactic acid and tartaric acid.

The base particles may comprise other ingredients, such as bleach actives, enzymes, perfumes, polymers, chelants, brighteners, hueing dyes, colorants, dye transfer inhibitors, dye fixative agents, silicones, fabric softening agents (such as clay), flocculants (such as polyethyleneoxide), suds suppressors, filler salts, and any combinations thereof. Alternatively, the base particles, or the detergent granules containing such base particles coated with PCC, may be mixed with particles containing the above-mentioned other ingredients, such as bleach actives, enzymes, perfumes, polymers, chelants, brighteners, hueing dyes, colorants, dye transfer inhibitors, dye fixative agents, silicones, fabric softening agents (such as clay), flocculants (such as polyethyleneoxide), suds suppressors, filler salts, and any combinations thereof, to form a fully-formulated solid detergent composition.

Suitable bleach actives of the present invention may include sources of hydrogen peroxide, bleach activators (such as tetra acetyl ethylene diamine and/or alkyl oxybenzene sulphonate), bleach catalysts (such as oxaziridinium bleach catalysts, transition metal bleach catalysts, especially manganese and iron bleach catalysts), pre-formed peracids (such as phthalimidoperoxycaproic acid), and photobleach (such as zinc and/or aluminium sulphonated phthalocyanine). A particularly suitable bleach includes a combination of a source of hydrogen peroxide with a bleach activator and/or a bleach catalyst.

Suitable enzymes may be selected from the group consisting of proteases, amylases, cellulases, lipases, bleaching enzymes (such as peroxidases/oxidases), pectate lyases, which include those of plant, bacterial or fungal origin and variants thereof.

Suitable polymers may be selected from the group consisting of carboxylate polymers, soil release polymer, anti-redeposition polymers, cellulosic polymers and care polymers.

A preferred polymer is a carboxylate polymer, more preferably a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers. It may be preferred that the carboxylate polymer has a weight average molecular weight of at least 30 kDa, or at least 50 kDa, or even at least 70 kDa. Preferred carboxylate polymers include: polyacrylate homopolymers having a molecular weight of from 4,000 Da to 9,000 Da; maleate/acrylate random copolymers having a molecular weight of from 30,000 to 100,000 Da, or from 50,000 Da to 100,000 Da, or from 60,000 Da to 80,000 Da.

Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

Suitable anti-redeposition polymers include polyethylene glycol polymers and/or polyethyleneimine polymers. Suitable polyethylene glycol polymers include random graft co-polymers comprising: (i) hydrophilic backbone comprising polyethylene glycol; and (ii) hydrophobic side chain(s) selected from the group consisting of: C4-C25 alkyl group, polypropylene, polybutylene, vinyl ester of a saturated C1-C6 mono-carboxylic acid, C1-C6 alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is Sokalan HP22.

Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof. Suitable carboxymethyl celluloses have a degree of carboxymethyl substitution from 0.5 to 0.9 and a molecular weight from 100,000 Da to 300,000 Da. Suitable carboxymethyl celluloses have a degree of substitution greater than 0.65 and a degree of blockiness greater than 0.45.

Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose. Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis). Other suitable care polymers include amino-silicone, which can provide fabric feel benefits and fabric shape retention benefits.

Suitable chelants are selected from: diethylene triamine pentaacetate (DTPA), diethylene triamine penta(methyl phosphonic acid), ethylene diamine-N′N′-disuccinic acid (EDDS), ethylene diamine tetraacetate (EDTA), ethylene diamine tetra(methylene phosphonic acid), hydroxyethane diphosphonic acid (HEDP), hydroxyethane di(methylene phosphonic acid), NTA, MGDA, GLDA and the like. A preferred chelant is EDDS and/or GLDA and/or MGDA. The composition preferably comprises EDDS or salt thereof. Preferably the EDDS is in S,S enantiomeric form. Preferably the composition comprises 4,5-dihydroxy-m-benzenedisulfonic acid disodium salt. Preferred chelants may also function as calcium carbonate crystal growth inhibitors such as: HEDP and salt thereof; N,N-dicarboxymethyl-2-aminopentane-1,5-dioic acid and salt thereof; 2-phosphonobutane-1,2,4-tricarboxylic acid and salt thereof; and combination thereof.

Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland).

Suitable perfumes comprise perfume materials selected from the group: (a) perfume materials having a Clog P of less than 3.0 and a boiling point of less than 250° C. (quadrant 1 perfume materials); (b) perfume materials having a Clog P of less than 3.0 and a boiling point of 250° C. or greater (quadrant 2 perfume materials); (c) perfume materials having a Clog P of 3.0 or greater and a boiling point of less than 250° C. (quadrant 3 perfume materials); (d) perfume materials having a C log P of 3.0 or greater and a boiling point of 250° C. or greater (quadrant 4 perfume materials); and (e) mixtures thereof. It may be preferred for the perfume to be in the form of a perfume delivery technology. Such delivery technologies further stabilize and enhance the deposition and release of perfume materials. Such perfume delivery technologies can also be used to further increase the longevity of perfume. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof.

Suitable silicones include polydimethylsiloxane and amino-silicones.

The base particles may comprise one or more filler salts, such as sodium sulfate or sodium chloride. Preferably, the base particles comprise from 30 wt % to 70 wt %, or from 40 wt % to 70 wt % of sodium sulfate as a filler salt.

### Process of Making the Base Particles

Typically, the base particles of the present invention can be prepared by any suitable method. For example: spray-drying, agglomeration, extrusion and any combination thereof.

A suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable. It may be preferred to heat the aqueous slurry mixture to elevated temperatures prior to atomization into the spray-drying tower. Typically, the spray-dried powder is subjected to cooling, for example an air lift. Typically, the spray-drying powder is subjected to particle size classification, for example a sieve, to obtain the desired particle size distribution. It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump. It may be preferred for a gas, such as air, to be introduced into the spray-drying process after the step of forming the aqueous slurry. It may be preferred for any inorganic ingredients, such as sodium sulphate and sodium carbonate, if present in the aqueous slurry mixture, to be micronized to a small particle size.

Preferably, the spray-dried powder has a particle size distribution such that weight average particle size is in the range of from 300 micrometers to 500 micrometers, and less than 10 wt % of the spray-dried particles have a particle size greater than 2360 micrometers.

Suitable agglomeration process comprises the step of contacting a detersive ingredient, such as a detersive surfactant, e.g. linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process. Other suitable detergent ingredients that may be agglomerated include polymers, chelants, bleach activators, silicones and any combination thereof. The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process. It may be preferred for the agglomerates to be subjected to a drying step, for example to a fluid bed drying step. It may also be preferred for the agglomerates to be subjected to a cooling step, for example a fluid bed cooling step. Typically, the agglomerates are subjected to particle size classification, for example a fluid bed elutriation and/or a sieve, to obtain the desired particle size distribution.

Preferably, the agglomerates have a particle size distribution such that weight average particle size is in the range of from 300 micrometers to 800 micrometers, and less than 10 wt % of the agglomerates have a particle size less than 150 micrometers and less than 10 wt % of the agglomerates have a particle size greater than 1200 micrometers. It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

Preferably, liquid ingredients, such as polymer(s) and/or silicone(s) and/or non-ionic surfactant(s) and/or perfume(s) as described hereinabove, are sprayed onto the base particles in a tumbling drum mixer, e.g., a Lodige KM mixer. More preferably, a liquid mixture of nonionic surfactant(s) and perfume is sprayed onto the base particles. Such sprayed-on materials may significantly increase the surface stickiness of base particles and render their flowability even poorer. Therefore, it is more desirable to provide a flow aid to help improving their flowability in the presence of such sprayed-on materials.

### Coating of Base Granules

Preferably but not necessarily, the base particles are formed by the above-mentioned spray-drying or agglomeration processes (or a combination of both in a mixture form)

PCC is added near the end of the process to form a coating layer over the base particles, either with or without the intermediate layer. The addition of PCC can be done in a similar tumbling drum mixer, such as a Lodige KM mixer, as mentioned hereinabove, to form detergent granules that each comprises a base particle coated with a PCC coating layer. The PCC coating layer can be a partial or complete coating of PCC material over the outer surface of a base particle, or at least a portion of such outer surface. Preferably, little or no PCC is present inside the base particle when the above-mentioned steps are followed.

Preferably, the resulting detergent granules comprises from 0.1% to 10%, more preferably from 0.2% to 9%, still more preferably from 0.5% to 8%, still more preferably from 1% to 7%, most preferably from 1.2% to 6%, of PCC by total weight of said detergent granules.

Before the coating of PCC, the base particles (either with or without the intermediate layer) are preferably characterized by a Blocking Orifice Diameter (BOD) of at least 12 mm, preferably at least 14 mm, more preferably at least 16 mm, still more preferably at least 18 mm, most preferably at least 20 mm, as measured by Test 5 hereinafter. Preferably, the coating of such base particles with PCC results in detergent granules (i.e., coated particles) that are characterized by a BOD of no more than 8 mm, preferably no more than 6 mm, more preferably no more than 5 mm, still more preferably no more than 4 mm, most preferably no more than 3 mm. The use of PCC as a flow aid, especially the use thereof to modify the relatively sticky surfaces of surfactant-containing base particles and to form free-flowing detergent granules, preferably achieves a Blocking Orifice Diameter Reduction Percentage (ΔBOD %) of more than 60%, preferably more than 70%, more preferably more than 75%, most preferably more than 80%, while ΔBOD % is calculated as follows:

$$Δ BOD \% = \frac{{BOD}_{Before} - {BOD}_{After}}{{BOD}_{Before}} \times 100 \%$$

wherein BOD_{Before} is the BOD of the surfactant-containing base particles before coating by PCC, and BOD_{After} is the BOD of the free-flowing detergent granules formed after coating the base particles with PCC.

### Solid Detergent Composition

The solid detergent composition of the present invention is a fully formulated, free-flowing particulate detergent composition comprising the detergent granules mentioned hereinabove. Typically, the solid detergent composition comprises the above-mentioned detergent granules, either without any other particles or in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

### Test Methods

The following techniques must be used to determine the properties of the detergent granules and detergent compositions of the invention in order that the invention described and claimed herein may be fully understood.

### Test 1: Bulk Density Measurement

The bulk density of a sample granular material is determined in accordance with Test Method B, Loose-fill Density of Granular Materials, contained in ASTM Standard E727-02, “Standard Test Methods for Determining Bulk Density of Granular Carriers and Granular Pesticides,” approved Oct. 10, 2002.

### Test 2: Surface Area Measurement

The specific surface area of a sample flow aid material is tested by N₂ gas adsorption-BET method using a JWGB with the model number of JW-BK100B, which is a standardized method described in the manual of JWGB.

### Test 3: Particle Size Distribution Test

The particle size distribution is measured by Malvern Mastersizer 2000, dry particles (e.g. PCC) is dispersed in water with around 15% obscuration, which is a dynamic laser diffraction technology.

All particulate samples are measured using the following measurement parameters:
Refractive index: 1.6;
Absorption: 0.1;
Result model: general purpose with normal and irregular option selected;
Measurement cycles per sample: 60;
Sample measurement time per cycle: 1 min;
Background measurement time: 2 min;
Obscuration filtering: off; and
Alarms: off.

Each sample is loaded into the Scirocco and then fitted with the general-purpose tray. The Scirocco is equipped with the fine mesh screen and approximately 20 to 25 flow dispersion spheres. The sample is then fed through the Mastersizer using a feeding air pressure of 3.5 bar and the vibratory feed rate is adjusted to give laser obscuration of 3 to 12%. After measurements, the results are recalculated to transform the volume-based distribution into a number-based distribution using the Result Transformation function in the Malvern software. When using the Result Transformation function, it is important to remember that the fundamental parameter which is measured is volume. Transformations to number or length should be treated with caution, particularly if:
1) The material measured shows a significant proportion (>15%) of sub-micron material.
2) If there is an unmeasured proportion of the distribution, as any errors are cubed when transforming to a number distribution.

### Test 4: Moisture Content Measurement

Two (2) grams of a sample material is tested in the Mettler Toledo HR73 Halogen moisture analyzer at 110° C. for 10 minutes. The percentage (%) of lost mass at the end of the measurement is recorded as the moisture content of the sample material.

### Test 5: FLODEX Measurement for Blocking Orifice Diameter (BOD)

The flowability of surfactant-containing particles or granules (e.g., the base particles with or without the intermediate layers, or the detergent granules of the present invention) is measured by using a FLODEX assembly. Specifically, the FLODEX assembly is set up as follows:
Insert the mounting post (2) into the base (1) while simultaneously inserting the shaft of the cylinder assembly (3) into the mounting post. Do not tighten the screws.
Gently rotate the mounting post into the base unit until the cylinder assembly is approximately in the center of the base. Then, tighten the screws (9) in the base.
Lightly tighten the cap screw (6) holding the cylinder assembly shaft to keep the cylinder assembly centered in place while continuing assembly.
Push the funnel ring stand (5) over the mounting post and into the approximate position shown. Then loosen the cap screw (6), hold the cylinder assembly shaft, and slide the cylinder assembly in and out until the center of the cylinder exactly lines up with the bottom of the funnel. Tighten the screw holding the cylinder assembly shaft. Be sure the cylinder is vertically in line with the shaft (2) before tightening the screw.
Turn the release lever (9) until the lever arm drops. Insert a flow measurement disk (8) of a suitable size with the number side down by first removing the plastic ring retainer (3) inserting the disk and replacing the ring retainer with the disk (8) in place. Following is a table showing standard orifice sizes (inside hole diameters) of the flow measurement disks:

| MM Marking on Disk | INCH; Tol. +/−.003 |
|---|---|
| 4 | .1575 |
| 5 | .1969 |
| 6 | .2362 |
| 7 | .2756 |
| 8 | .3150 |
| 9 | .3543 |
| 10 | .3937 |
| 12 | .4724 |
| 14 | .5512 |
| 16 | .6299 |
| 18 | .7087 |
| 20 | .7874 |
| 22 | .8661 |
| 24 | .9449 |
| 26 | 1.0236 |
| 28 | 1.1023 |
| 30 | 1.1811 |
| 32 | 1.2598 |
| 34 | 1.3386 |

Manually press the closure plate (5) against the disk and turn the lever back to hold. Test by carefully and slowly moving the release lever forward until the closure plate falls without vibration and into a vertical position.
Move the funnel down until it is 2 cm above the top of the cylinder. It is important that this dimension remain constant for the entire test. If the loading funnel is too high above the cylinder, the powder may not fill with the same untapped bulk density for each successive test.
A metal bowl or foil should be used to collect the sample. Metal and foil discharge electrostatic potential that builds up between particles of powder. For this reason, the loading funnel is stainless steel.
Please note that if the powder is not collected on a conductive sheet, it may acquire electrostatic charge from the previous test and if the same sample is re-run it may not pass through the same minimum hole.
Prepare to start the test with the flow disk of a 12 mm orifice size. Starting disks with more suitable orifice sizes can be used as the characteristics of the sample powder become better known.

Samples of surfactant-containing particles or granules are then obtained. After sampling, the appropriate sample mass (Mₛₐₘₚₗₑ) is determined by measuring the loose fill (repour) bulk density (ρ_{bulk}) using the method described in Test 1 hereinabove and then multiplying the density by the target volume (150 ml)

Mₛₐₘₚₗₑ=150 ml×ρ_{bulk}

The mass of each sample is recorded before the start of each test measurement.

Subsequently, each sample is loaded carefully into the funnel of the FLODEX assembly. If necessary, the bottom of the funnel may be tapped lightly, so that the sample flows into the receptacle cylinder assembly (i.e., hopper) without packing. DO NOT over-tap the funnel to disturb the hopper. DO NOT otherwise disturb the hopper. The sample should fill the hopper to within about 1 cm of the top of the hopper. After loading, the sample is allowed to sit for exactly 30 seconds so that the sample can settle in the hopper.

Next, the release lever of the FLODEX assembly is slowly turned until the closure drops open without vibration. The mass of the discharged powder in the collection vessel is then weighed and recorded. The test is classed as positive when the open hole at the bottom is visible when looking down from the top.

Do not tap or shake the FLODEX assembly during the test period. To empty the remaining contents of the hopper, close the orifice and empty the remaining material by inverting the hopper assembly, pouring the contents into a separate container.

For positive results (hole visible), the steps are repeated with flow measurement desks with reducing orifice sizes, until the test becomes negative (i.e., when the open hole at the bottom is no longer visible when looking down from the top). The last orifice size is then recorded as the Blocking Orifice Diameter (BOD). Typically, the smaller the BOD, the more flowable the sample practices or granules tested.

### Test 6: Color Protection Test

Color protection test is conducted by using Hair FLA machine as below:
Water volume: 10 L
Water type: 16 gpg hardness water (around 2.2 mmol/L)
Powder Concentration: 3000 ppm
Fabric Tracer: Colored cotton fabric, Red/Green/Black/Blue No-pretreat; T-shirt*3+Towel*3, which were pre-stripped with China National Standard powder detergent (from Taiyuan, China) in DI water by 6 times 1. Measure the L*a*b* of the fabric tracers before washing.
2. Add Load and Powder in the washing machine (30 C temperature, 800 rpm)
3. Wash for 30 minutes
4. Rinse for 10 minutes.
5. Repeat 4 cycles
6. Measure the L*a*b* of the tracer washed with detergent by using IA measurement.

### Test 7: Softening Performance Test

A softening performance test is carried out for characterizing the softening performance. Particularly, samples of solid detergent compositions are prepared. Then, towels (3 pieces for each sample) are washed by the following steps:
1. Add Load and Powder in the washing machine (30 C temperature, 800 rpm)
2. Wash for 30 minutes
3. Rinse for 10 minutes.
4. Repeat 4 cycles

Then, a panel of 15 people grades the towels for each sample by using the scales below. Thus, scores for softening performance for each sample are obtained by calculating the average score of 15 people.

| | Scores for softening performance |
|---|---|
| Scale | −2 = very hard |
| | −1 = relatively hard |
| | 1 = relatively soft |
| | 2 = very soft |
| Note | The towel softness is assessed by using the same hand |

### EXAMPLES

### Example 1: Improved Color Protection of Detergent Granules Comprising PCC with Medium Surface Area

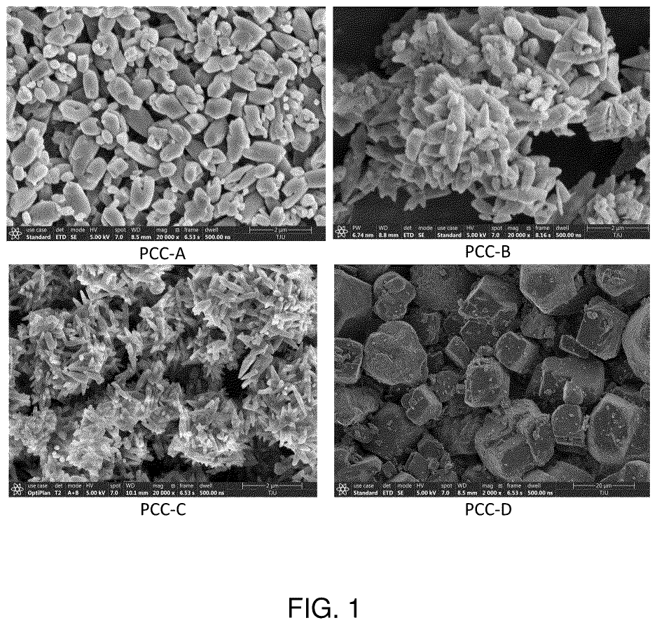

Detergent Granules Samples 1 to 4 were prepared as described below. Spray-dried particles with the composition as shown in Table 1 below except PCC (i.e., LAS, sodium carbonate and sodium sulfate) are first formed. Typically, the spray-drying process comprises the step of contacting alkyl benzene sulphonate anionic detersive surfactant and water to form an aqueous mixture. Particularly, the salts (Na2CO3 and Na2SO4) and other ingredients are contacted with the aqueous mixture to form a crutcher mixture. Typically, the crutcher mixture comprises at least 20 wt % water. This level of water in the crutcher is preferred, especially when the salt is sodium sulphate. This is because this level of water promotes good dissolution of the sodium sulphate in the crutcher mixture. Typically, the crutcher mixture is then spray-dried to form the LAS spray-dried particle. Preferably, the inlet air temperature during the spray-drying step is 250° C. or lower. Controlling the inlet air temperature of the spray-drying step in this manner is important due to the thermal stability of the crutcher mixture due to the high organic level in the crutcher mixture. The spray-drying step can be co-current or counter-current. Next, such spray-dried particles are mixed with PCC powder (i.e. PCC-A, PCC-B, PCC-C and PCC-D) having different morphologies as shown in Table 2 to form a coated particles. The SEM photos of the PCC are shown in FIG. 1, indicating morphologies of PCC particles.

TABLE 1

| Ingredients (Active %) | Sample 1 | Sample 2 | Sample 3 | Sample 4 |
|---|---|---|---|---|
| Linear alkyl benzene | 15% | 15% | 15% | 15% |
| sulphonate (LAS) | | | | |
| Na₂CO₃ | 25% | 25% | 25% | 25% |
| PCC-A¹ | 6% | — | — | — |
| PCC-B² | — | 6% | — | — |
| PCC-C³ | — | — | 6% | — |
| PCC-D⁴ | — | — | — | 6% |
| Na₂SO₄ | Balance | Balance | Balance | Balance |

¹PCC-A: Vicality Albaglos from Minerals Technologies Inc.
²PCC-B: PCC Q/ZJTS 015-2022 from Zheijang Tianshi Nanotech Ltd.
³PCC-C: 92G from Imerys
⁴PCC-D: Scoralite from ICL Industrial Products

TABLE 2

| PCC name | Morphology |
|---|---|
| PCC-A | Prismatic (major)/Cubic (minor) |
| PCC-B | Scalenohedral |
| PCC-C | Scalenohedral |
| PCC-D | Cubic |

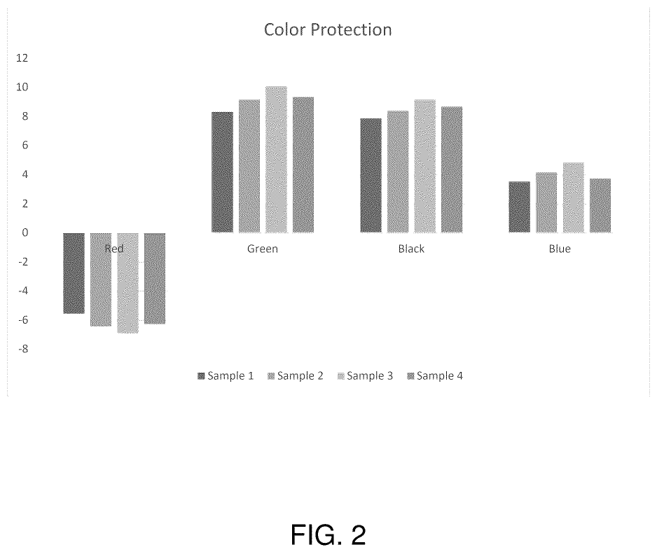

Then, the a*, b* and L* were measured for Samples 1 to 4, in accordance with Test 6: Color Protection test as described hereinabove. The results are shown in Table 3 and FIG. 2 below in which the higher value indicates the worse color protection, while the lower value indicates better color protection. It is unexpectedly discovered that PCC having a morphology of prismatic (i.e., PCC-A) can provide a better color protection compared to PCC having other morphologies.

TABLE 3

| | | Red | Green | Black | Blue |
|---|---|---|---|---|---|
| Sample | PCC Morphology | a* | a* | L* | b* |
| 1 | Prismatic (major) | −5.57 | 8.31 | 7.84 | 3.50 |
| | Cubic (minor) | | | | |
| 2 | Scalenohedral | −6.45 | 9.16 | 8.39 | 4.15 |
| 3 | Scalenohedral | −6.91 | 10.08 | 9.17 | 4.84 |
| 4 | Cubic | −6.27 | 9.33 | 8.67 | 3.71 |

### Example 2: Improved Softening Performance of Detergent Granules Comprising PCC with Medium Surface Area

In order to explore if there is any other benefit provided by the addition of PCC, the softening scores were determined for Samples 1 to 4, in accordance with Test 7: Softening Performance test as described hereinabove. The results are shown in Table 4 below in which the higher value indicates the better softening performance. Surprisingly, it is unexpectedly discovered that PCC having a morphology of prismatic (i.e., PCC-A) can provide a softening performance while PCC having other morphologies cannot.

TABLE 4

| Sample | PCC Morphology | Softening score |
|---|---|---|
| 1 | Prismatic (major) | +0.8 |
| | Cubic (minor) | |
| 2 | Scalenohedral | −1.6 |
| 3 | Scalenohedral | −0.9 |
| 4 | Cubic | −0.7 |

### Example 3: Detergent Granule Compositions

Examples A-E hereinafter illustrate detergent granules comprising PCC having a medium surface area.

TABLE 5

| | Wt % | | | | |
|---|---|---|---|---|---|
| Ingredients | A | B | C | D | E |
| LAS | 6-15 | 2.6-16 | 11-27 | 15.25-21.5 | 0-50 |
| Mid-Cut AS | 0.29-0.5 | 0-7 | 0-15 | 0-4 | 0-20 |
| Methyl ester sulfonate (MES) | 0-2 | 0-6 | — | — | 0-10 |
| Soap | 0.4-8.8 | 0.1-11 | — | 0-2.7 | 0-15 |
| Nonionic surfactant | 0.8-2.5 | 1-3 | — | 0-2.55 | 0-5 |
| Na2CO3 | 13-25 | 4-20 | 9.42-30.05 | 8.42-42.10 | 0-50 |
| Na2SO4 | 25-40 | 30-60 | 20.39~51.27 | 0~57.42 | 0-60 |
| Protease | 0.1-0.2 | 0-0.5 | 0.0762~0.93 | 0~1.32 | 0-1 |
| Cellulase | 0-0.12 | 0-0.32 | | | 0-1 |
| Mananase | 0-0.1 | 0-0.12 | | | 0-1 |
| Lipase | 0-0.05 | 0-0.08 | | | 0-1 |
| Brightener (C.I. fluorescent brightener | 0-0.3 | 0-0.1 | 0-0.4 | 0-0.2 | 0-1 |
| 260 or C.I. fluorescent brightener 351) | | | | | |
| Aesthetic particles (speckles/rings/etc.) | — | — | 0.5~0.8 | 1~2.0 | 0-5 |
| Hueing dyes | — | — | — | 0.09~0.33 | 0-1 |
| Percarbonate | 0-2 | 0-24 | 0~2.72 | 0~7.2 | 0-30 |
| Bleach activator (TAED/etc.) | — | — | 0~0.4139 | 0~0.58 | 0-1 |
| Silicate | 8-17 | 0-11 | 0-5 | 0-20 | 0-30 |
| Carboxylate polymer (such as | 0-5 | 0-2.5 | 0~3.5 | 0.08~0.25 | 0-5 |
| polyacrylates or copolymers of maleic | | | | | |
| acid and acrylic acid) | | | | | |
| CMC or Blocky CMC | 0.18-0.3 | 0-0.6 | 0.07~0.52 | 0-1 | 0-1 |
| Chelant (e.g., DTPA, GLDA, MGDA, | — | — | 0~0.2969 | — | 0-1 |
| EDDS, HEDP, etc.) | | | | | |
| Zeolite (as a builder, not flow aid) | 1.7-3.0 | 4-11 | 1.68~5.0 | 0.05~11.9 | 0-20 |
| Perfumes (e.g., SEA, sprayed-on | 0-1 | — | 0-1 | 0-1 | 0-1 |
| perfumes, perfume microcapsules, etc.) | | | | | |
| Silicone | — | — | 0-0.005 | — | 0-0.1 |
| PCC-A¹ | 0.5-5 | 0.5-5 | 0.5-5 | 0.5-5 | 0.1-10 |

¹PCC-A: Vicality Albaglos from Minerals Technologies Inc.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid detergent composition comprising a plurality of detergent granules, wherein said each of said detergent granule comprises precipitated calcium carbonate in which the precipitated calcium carbonate comprises calcium carbonate particles having a morphology of prismatic.

2. The solid detergent composition according to claim 1, wherein precipitated calcium carbonate further comprises calcium carbonate particles having a morphology of cubic.

3. The solid detergent composition according to claim 1, wherein said precipitated calcium carbonate is characterized by:
a bulk density ranging from 100 g/L to 1000 g/L; and/or
a particle size distribution characterized by: (1) a D50 ranging from 0.1 micron to 50 microns; and/or (2) a D90 of less than 50 microns; and/or
a moisture content of less than 3%; and/or
a surface area of from 1 m²/g to 20 m²/g.

4. The solid detergent composition according to claim 1, wherein the precipitated calcium carbonate content ranges from 0.1% to 9% by total weight of said solid detergent composition.

5. The solid detergent composition according to claim 1, wherein said each of said detergent granule comprises a base particle comprising one or more surfactants; and a coating layer over said base particle, said coating layer comprising precipitated calcium carbonate,
wherein said base particle is substantially free of precipitated calcium carbonate.

6. The solid detergent composition according to claim 5, wherein the surfactant content ranges from 6% to 70% by total weight of said solid detergent composition.

7. The solid detergent composition according to claim 5, wherein said base particle comprises one or more anionic surfactants selected from the group consisting of: (1) a C₁₀-C₂₀ linear or branched alkylalkoxylated sulfate (AAS) surfactant; (2) a C₆-C₂₀ linear or branched unalkoxylated alkyl sulfate (AS) surfactant; (3) a C₁₀-C₂₀ linear alkyl benzene sulphonate (LAS) surfactant; and (4) combinations thereof.

8. The solid detergent composition according to claim 1, wherein each of said detergent granules further comprises alkali metal carbonate,
wherein the content of alkali metal carbonate ranges from 6% to 70%, by total weight of said solid detergent composition.

9. The solid detergent composition according to claim 1, wherein each of said detergent granules further comprises one or more ingredients selected from the group consisting of polymers, silicones, perfumes, nonionic surfactants, and combinations thereof; and wherein each of said detergent granules further comprises a mixture of perfume(s) and nonionic surfactant(s).

10. The solid detergent composition according to claim 1, wherein each of said detergent granules further comprises one or more enzymes.

11. The solid detergent composition according to claim 1, wherein the base particles of said detergent granules are selected from the group consisting of spray-dried particles, agglomerates, and mixtures thereof.
